(19) United States
(12) Patent Application Publication
(10) Pub. No.: US 2005/0274154 A1
(43) Pub. Date: Dec. 15, 2005

(54) Appliance wire harness clip

(75) Inventor: Daryl T. Johnson, Grinnell, IA (US)

Correspondence Address: MCKEE, VOORHEES & SEASE, P.L.C.;ATTN: MAYTAG, 801 GRAND AVENUE, SUITE 3200, DES MOINES, IA, 50309-2721, US

(73) Assignee: Maytag Corporation, Newton, IA (US)

(21) Appl. No.: 10/865,467

(22) Filed: Jun. 10, 2004

(51) Int. Cl. B08B 3/12

(52) U.S. Cl. 68/3 R

(57) ABSTRACT

A simple, low cost and functional clip is provided for retaining a wire harness in a channel on the inner surface of a cabinet of an appliance. The clip is flexible so as to be snap fit into the channel without the use of fasteners or tools. The clip prevents the wire harness from sagging or dropping or from being pinched between structures of the appliance.

### BACKGROUND OF THE INVENTION

Washing machines typically have a cabinet housing a rotating drum in which clothes and other laundry is washed. Both top loading and front loading washing machines are well known. In a top loading machine, the cabinet includes a top cover and access opening, and a lid pivotally mounted on the top cover for movement between open and closed positions relative to the access opening. A control panel is normally provided on top of the top cover at the rear of the machine, with dials, buttons or switches which can be selectively actuated by a user to control operation of the washing machine.

Recently, some washing machines have been provided with a lock for the lid which prevents the lid from opening when the machine is operating. In a top loading machine, the lid is normally hinged at the rear edge, with the lock being provided at the front edge. The lock may take various forms, such as an electronically actuated solenoid, with a sensor to determine when the lid is down. In prior art machines having such a lid lock, wires extend from the control panel through a rigid conduit secured to the underside of the top panel and to the lock mechanism. The rigid conduit prevents sagging or drooping of the wires into the cabinet where there are moving parts and prevent the wires from getting pinched between the lid and the top cover, or between the top cover and the cabinet. However, the rigid conduit adds undesirable costs in the form of material and labor during assembly.

Therefore, a primary objective of the present invention is the provision of an improved mechanism for securing the wires in position inside the cabinet of an appliance.

A further objective of the present invention is the provision of a top loading washing machine having a clip to retain a wire harness adjacent the lower surface of the top cover so as to provide power from a control panel at the rear edge of the top cover to a locking mechanism near the front edge of the top cover.

Another objective of the present invention is the provision of a wire harness clip which can be quickly and easily secured to the top cover without the use of fasteners or tools.

Still another objective of the present invention is the provision of a top loading washing machine wire harness clip for holding wires in position without securing the wires to the clip.

Yet another objective of the present invention is the provision of an improved method of wiring a washing machine by retaining a wire harness between a clip and the lower surface of the top cover of the machine.

Another objective of the present invention is the provision of a washing machine wire harness clip which is economically manufactured, and durable and safe in use.

These and other objectives will become apparent from the following description of the invention.

### SUMMARY OF THE INVENTION

A wire harness clip is provided for an appliance so as to retain the wire harness in position adjacent the inside surface of the cabinet of the machine. More particularly, the wire harness is routed from the control panel at the rear of the machine to a front edge of the top cover while extending along the lower surface of the top cover. A clip is mounted to and beneath the top cover such that the wire harness extends over the clip for support by the clip adjacent the lower surface of the top cover. The clip is received in a channel on the bottom surface of the top cover. The clip length is greater than the channel of width, such that the clip is flexed or bowed and then inserted into the channel, and then released so as to expand into retentive engagement with the side walls of the channel. The wires extend along the channel between the clip and the inner surface of the cabinet.

### BRIEF DESCRIPTION OF THE DRAWINGS

FIG. 1 is a perspective view of a top loading washing machine having the wire harness clip of the present invention.

FIG. 2 is a bottom plan view of the top cover of a top loading washing machine having the wire harness clip of the present invention.

FIG. 3 is a sectional view taken along lines 3-3 of FIG. 2.

FIG. 4 is an enlarged plan view of the clip taken along lines 4-4 of FIG. 2.

FIG. 5 is an enlarged sectional view of the clip taken along lines 5-5 of FIG. 3.

FIG. 6 is a perspective view of the clip as manufactured, in an uninstalled state.

FIG. 7 is a perspective view of the clip as installed.

### DETAILED DESCRIPTION OF THE PREFERRED EMBODIMENT

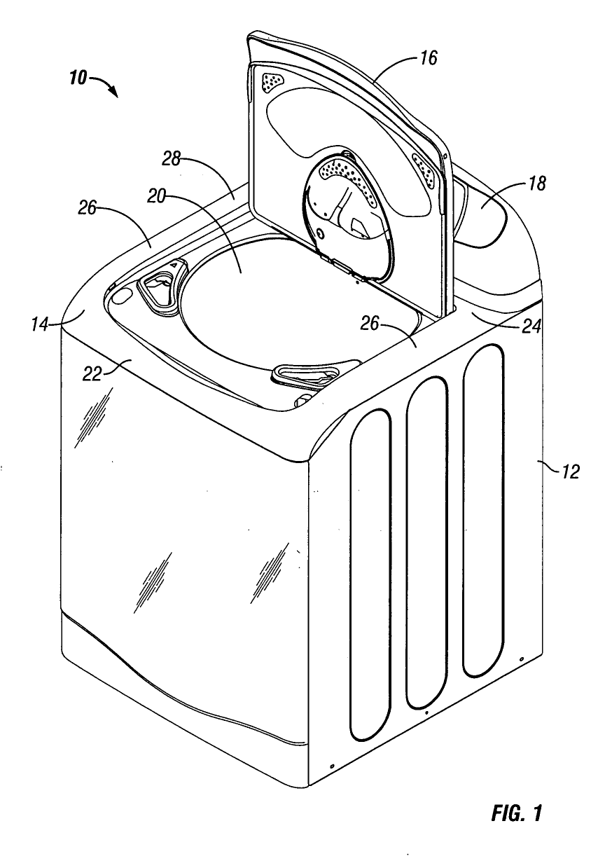

FIG. 1 shows a washing machine 10 with a cabinet 12, a top cover 14, a lid 16, and a control panel 18 at the rearward edge of the top cover 14. The top cover 14 includes an opening 20 to provide access to the tub inside the cabinet 12. The lid 16 is pivotally mounted to the top cover 14 so as to be moveable between open and closed positions relative to the access opening 20.

The top cover 14 has a front edge 22, a rear edge 24, opposite side edges 26, an upper surface 28, and a lower surface 30. A channel 32 is formed in the lower surface 30 adjacent each side edge 26 of the top cover 14.

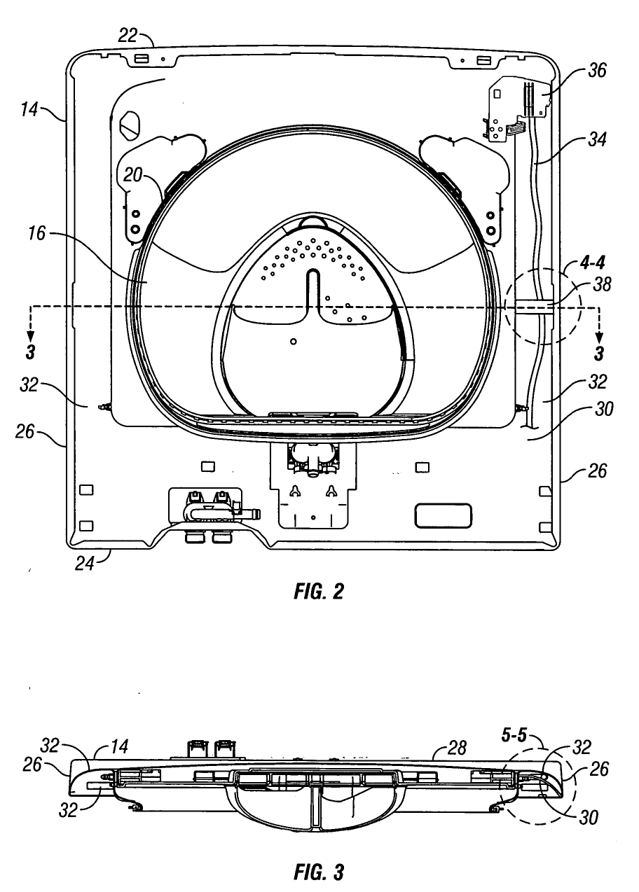

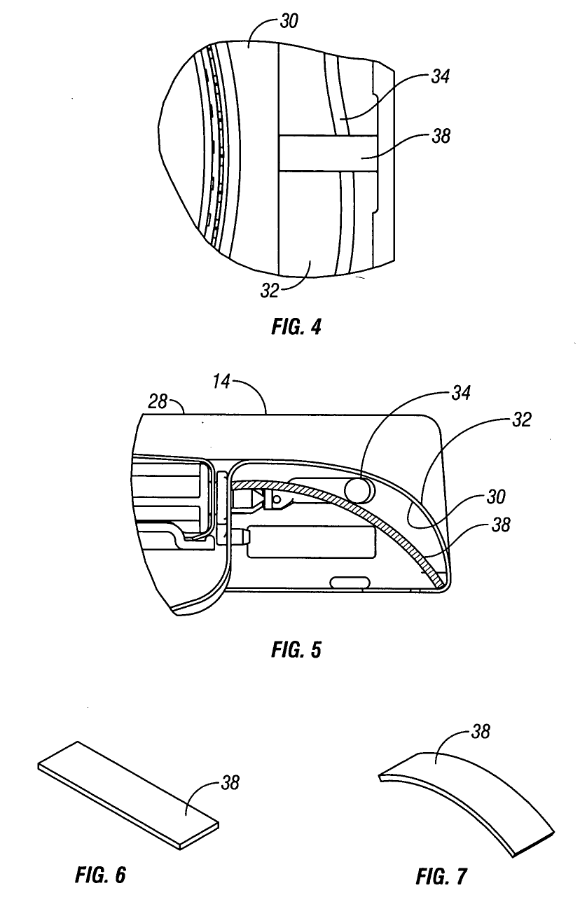

A wire harness 34 resides within each channel 32 so as to extend from the control panel 18 to a lock mechanism 36 near the front edge 22 of the top cover 14. In FIG. 2, only one wire harness 34 and lock mechanism 36 are shown on one side of the top cover 14. It is understood that an identical wire harness 34 and lock mechanism 36 is provided adjacent the opposite side edge of the top cover 14. The wires in the harness 34 provide electrical power to the lock mechanism 36 which locks the lid 16 in the closed position when the washing machine 10 is operating.

The present invention is directed to a clip 38 which retains the wire harness 34 in position within the channel 32, and prevents the harness 34 from drooping or sagging into the cabinet 12, or from getting pinched between the top cover 14 and the cabinet 12, or between the cover 14 and the lid 16. The clip 38 is a flexible or resilient member made of plastic, metal or other suitable material. When the clip 38 is manufactured, it has a flat profile, as shown in FIG. 6. When the clip 38 is installed in the channel 32, it has a curved profile, as shown in FIGS. 5 and 7. The clip 38 engages the sidewalls of the channel 32 so as to be retained in the channel 32 without the use of fasteners or tools. Since the upper surface 28 of the top cover 14 is normally porcelained steel that is visible to the user, it is undesirable to have any fastener holes through the steel to retain the clip 38. The length of the clip 38 is greater than the width of the channel 32, and the resilient clip 38 quickly and easily snaps into the channel 32 so that the wire harness 34 is supported and retained by the clip 38.

The wiring method of the present invention includes the steps of routing the wire harness 34 from the control panel 18 to the front edge 22 of the top cover 14 so that the harness 34 extends within the channel 32 on the lower surface 30 of the top cover 14. The clip 38 is then snap fit into the channel so as to retain the harness 34 between the clip 38 and the lower surface 30 of the top cover 14.

It is understood that the clip may also be used on a front loading washing machine to retain a wire harness adjacent the cabinet of the machine. The invention may also have broad application in other appliances where a wire harness 34 is routed within a channel 32 of a cabinet or enclosure 12.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. An improved washing machine comprising:
a top cover having a front edge, opposite side edges, a rear edge, an access opening, an upper surface and a lower surface;
a lid pivotally connected to the top cover for movement between open and closed positions relative to the access opening;
a control panel adjacent the rear edge of the top cover;
a powered element mounted to and under the top cover;
a wire harness extending between the control panel and the powered element; and
a clip to retain the wire harness adjacent the lower surface of the top cover.

2. The washing machine of claim 1 wherein the clip is resilient.

3. The washing machine of claim 1 wherein the clip is secured to the top cover without the use of fasteners.

4. The washing machine of claim 1 wherein the lower surface of the top cover has a channel through which the wire harness extends.

5. The washing machine of claim 4 wherein the channel has opposite sides, and the clip retentively engages the opposite sides of the channel to retain the wire harness in the channel.

6. The washing machine of claim 4 wherein the clip has a length and the channel has a width, with the clip length being greater than the channel width.

7. The washing machine of claim 1 wherein the clip is flat after manufacture and bowed after installation.

8. The washing machine of claim 1 wherein the wire harness is supported by the clip without securement to the clip.

9. An improved appliance having a cabinet with a channel formed therein, the cabinet having inner and outer surfaces, the improvement comprising:
a wire harness routed within the cabinet so as to extend along the inner surface of the cabinet; and
a clip mounted to the cabinet such that the wire harness extends between the clip and the inner surface so as to be supported by the clip adjacent the inner surface of the cabinet.

10. The appliance of claim 9 wherein the inner surface of the cabinet has a channel through which the wire harness extends.

11. The appliance of claim 10 wherein the channel has opposite sides, and the clip retentively engages the opposite sides of the channel to retain the wire harness in the channel.

12. The appliance of claim 10 wherein the clip has a length and the channel has a width, with the clip length being greater than the channel width.

13. The appliance of claim 9 wherein the clip is secured to the cabinet without the use of fasteners.

14. The appliance of claim 9 wherein the wire harness is supported by the clip without securement to the clip.

15. The appliance of claim 9 wherein the clip is flat after manufacture and bowed after installation.

16. The appliance of claim 9 wherein the clip is resilient.

17. A method of wiring an appliance having a cabinet with inner and outer surfaces, the cabinet having a channel formed therein, the method comprising:
routing a wire harness in the channel of the cabinet so that the wire harness extends along an inner surface of the cabinet; and
mounting a clip to the channel so as to retain the wire harness between the clip and the inner surface of the cabinet.

18. The method of claim 17 wherein the clip is mounted to the channel without the use of fasteners.

19. The method of claim 17 wherein the clip is mounted to the channel solely by compressive forces applied by the channel.

20. The method of claim 17 wherein mounting the clip to the channel includes retentively engaging opposite ends of the clip within the side walls of the channel.

21. The method of claim 17 wherein the clip is flexible, and mounting the clip comprises snap fitting the clip to the inner surface of the cabinet, so that the clip retentively engages side walls of the channel.
